(19) United States
(12) Patent Application Publication
(10) Pub. No.: US 2015/0310160 A1
(43) Pub. Date: Oct. 29, 2015

(54) METHOD, SYSTEM AND COMPUTER PROGRAM PRODUCT FOR GENERATING HIGH DENSITY REGISTRATION MAPS FOR MASKS

(71) Applicant: KLA-TENCOR CORPORATION, Milpitas, CA (US)

(72) Inventors: Frank LASKE, Weilmuenster (DE); Mohammad M. DANESHPANAH, Foster City, CA (US); Pradeep SUBRAHMANYAN, Los Altos, CA (US); Yalin XIONG, Pleasanton, CA (US)

(21) Appl. No.: 14/795,576

(22) Filed: Jul. 9, 2015

Related U.S. Application Data
(63) Continuation of application No. PCT/US2015/024060, filed on Apr. 2, 2015.
(60) Provisional application No. 61/974,001, filed on Apr. 2, 2014.

(51) Int. Cl. G06F 17/50

(52) U.S. Cl. CPC G06F 17/5081

(57) ABSTRACT

A method and system for generating high density registration maps for masks is disclosed. A data preparation module generates a plurality of anchor points of the mask. Additionally, the data preparation module generates a plurality of sample points. Weights are generated as well in the data preparation module and the weights are used later on in the data fusion module. The positions of anchor points are measured with a registration tool in a mask coordinate system according to a generated recipe. The positions of sample points are determined with an inspection tool in a mask coordinate system according to a generated recipe. The measured positions of the anchor points and the measured positions of the sample points are passed to a data fusion module where a registration map is determined.

### CROSS REFERENCE TO RELATED APPLICATIONS

This application is filed under 35 U.S.C. §120 and §365(c) as a continuation of International Patent Application Serial No. PCT/US15/24060, filed on Apr. 2, 2015, which application claims the benefit under 35 U.S.C. 119(e) of U.S. Provisional Patent Application No. 61/974,001 filed on Apr. 2, 2014, which applications are incorporated herein by reference in their entirety.

### FIELD OF THE INVENTION

The present invention refers to a method for generating high density registration maps for masks.

Furthermore, the present invention refers to a system for generating high density registration maps for masks.

Furthermore, the present invention refers to a computer program product disposed on a non-transitory computer readable medium.

### BACKGROUND OF THE INVENTION

A mask (may also be referred to as a photomask or reticle) is a device that physically stores a pattern. The pattern is transferred to a wafer by lithography.

Mask registration metrology and mask inspection have traditionally been decoupled from one another due to their inherently conflicting requirements.

Mask registration is usually implemented using a stepping approach and involves positioning the reticle under the imaging optics for a period of time to image through focus steps. During registration measurement, the position of the reticle is held to tight absolute accuracy bounds by regulating the temperature of the measurement chamber very tightly and using high precision displacement metrology. Such an approach while guaranteeing tight bounds on absolute accuracy does not lend itself to a high throughput thus limiting the number of points on the reticle that can be measured.

For example, U.S. Pat. No. 8,582,113 discloses a device for determining the position of a structure on an object in relation to a coordinate system. The object is placed on a measuring table which is movable in one plane. At least one optical arrangement is provided which comprises an illumination apparatus for reflected light illumination and/or transmitted light illumination.

Additionally, several other US patents, like U.S. Pat. No. 8,248,618, U.S. Pat. No. 8,352,886 or U.S. Pat. No. 7,823,295, disclose devices or methods for determining the positions of structures on a mask.

On the other hand, mask inspection is implemented with a scanning approach using a Time Delay Integration (TDI) sensor. Absolute position accuracy is less important during mask inspection since the primary motive is to detect and classify defects on the mask. Image swaths from a mask inspection are also divided up into sub-patches which are realigned algorithmically to remove low-frequency image shifts (such as those due to temperature fluctuations) further reducing absolute accuracy.

Mask inspection systems are disclosed in U.S. Pat. No. 8,855,400, US patent application US 2014/0217298, U.S. Pat. No. 8,498,468 or U.S. Pat. No. 7,564,545 B2.

Especially, U.S. Pat. No. 8,624,971 discloses an inspection system for inspecting a surface of a wafer/mask/reticle. A modular array can include a plurality of TDI sensor modules, each TDI sensor module having a TDI sensor and a plurality of localized circuits for driving and processing the TDI sensor. The plurality of TDI sensor modules can be positioned to capture a same inspection region or different inspection regions. Spacing of the sensor modules can be arranged to provide 100% coverage of the inspection region in one pass or for fractional coverage requiring two or more passes for complete coverage.

The present systems or methods for mask registration metrology or mask inspection systems do not provide full mask registration map measurements. Metrology systems alone are not fast enough to cover the full mask. On the other hand, inspection systems alone are not accurate enough for registration metrology. The old method fails due to the need for a higher density registration map of a reticle which is in turn due to the increasing demands on both overlay and CD uniformity on wafer as feature sizes shrink. As a result, with limited number of samples from registration metrology, either good masks get rejected or bad masks get accepted due to insufficient coverage of the reticle.

### BRIEF SUMMARY OF THE INVENTION

It therefore is an object of the invention to provide a method for full mask registration map measurement which is fast enough to cover the full mask and accurate enough for registration metrology.

This object is achieved by a method for generating high density registration maps for masks comprising the following steps (note steps d) and e)+f) are interchangeable):

generating in a data preparation software module from the pattern design database of a mask and from a noise model of a registration tool a plurality of anchor points and a recipe for the registration tool;

generating in the data preparation software module from the pattern design database a mask and from a noise model of an inspection tool a plurality of sample points and a recipe for the inspection tool;

generating weights in the data preparation module for each anchor point;

measuring positions of the anchor points in a mask coordinate system with the registration tool according to the generated recipe;

scanning the full (or partial) area of the mask with the inspection system and extract a position measurement for each patch;

measuring positions of the anchor points in the mask coordinate system with respect to sample points on a same or adjacent swaths with the inspection tool according to the generated recipe; and

passing the measured positions of the anchor points and the measured positions of the sample points to a data fusion module, to determine a corrected set of registration measurement points under the influence of the generated weights of each anchor point on adjacent sample points. Note that data fusion module can be embedded into the inspection tool or as a separate module.

Also note the method further comprises passing the information about the anchor point measurement including position and image render parameters from the registration tool to the inspection tool for improved accuracy.

It is a further an object of the invention to provide a system for full mask registration map measurement which is fast enough to cover the full mask and accurate enough for registration metrology.

This object is achieved by a system for generating high density registration maps for masks, the system includes a data preparation software module which generates a plurality of anchor points, a plurality of sample points, a plurality of weights and at least one first recipe and at least one second recipe, a registration tool connected to the data preparation module to determine data for positions of the anchor points on the mask with regard to the at least one first recipe, an inspection tool connected to the data preparation module to determine data for positions of the sample points on the mask with regard to the at least one second recipe, a data fusion software module connected to the registration tool, the inspection tool and the data preparation software module in order to generate with the weights at least one registration map with a corrected set of registration points.

Note the registration tool can provide additional data learned from the mask (e.g., image rendering model) to the inspection too (or data fusion module) for improved accuracy.

The advantage of the inventive method and system is a higher density registration map of a reticle is obtained which in turn covers the increasing demands on both overlay and CD uniformity as feature sizes shrink. As a result, the entire mask is inspected to be within the mask registration error budget leading to no good masks get rejected and no bad masks get accepted.

According to one embodiment of the method, a graphical representation of the registration map of the mask is displayed on a display. The graphical representation shows the corrected set of registration points, wherein each registration point is provided with an error bar.

In an embodiment, the sample points, the anchor points and the weights are determined based on expected measurement error on both metrology and inspection tools. In a preferred embodiment, the generated number of anchor points is less than the generated number of sample points. Preferably, approximately 103 anchor points are generated and/or approximately 106 sample points are generated. The generated sample points may be up to 108 or even larger.

In an embodiment, the sample points, measured by the inspection tool, are cast over the entire mask by the data fusion module, according to the generated weights, into a mask coordinate frame as established by the registration tool to obtain the registration map of the mask. Preferably, the previously determined weights are used to determine the influence of a specific anchor point on the adjacent sample points in the mask coordinate frame. Preferably, bounds are established for potential errors between sample points according to a predetermined interpolation scheme. Preferably, the predetermined interpolation is realized by using influence functions.

In an embodiment, a user can regrid the displayed registration map over the sample points over a different set of points. Preferably, the different set of points is on a regularly spaced grid

In an embodiment of the inventive system for generating high density registration maps for masks, the data preparation module has at least a first input for providing mask design data in order to search for the appropriate anchor points as well as sample points. The design data for anchor and sample points are rendered in the registration tool and the inspection tool for position measurement. A second input of the data preparation module provides a noise model for the registration tool and the inspection tool.

According to a preferred embodiment of the invention, a first recipe module is connected to an anchor point output of the data preparation module and connected to an input of the registration tool. A second recipe module is connected to a sample point output of the data preparation software module and connected to an input of the inspection tool.

In an embodiment, the data fusion software module is configured to take the data of the measured positions of the anchor points via the output of the registration tool. Via the output of the inspection tool the data of the measured sample points are taken. A corrected set of registration points is generated along with the weights. According to a possible embodiment of the invention, a display is connected to the data fusion module for displaying bounded interpolation errors between anchor points over the entire mask.

In an embodiment, the number of anchor points is less than the number of sample points.

According to a further aspect of the invention, a computer program product is provided, which is disposed on a non-transitory computer readable medium. The computer program product comprises computer executable process steps operable to control a computer to: obtain positions of a plurality of anchor points in a mask coordinate system measured by a registration tool according to a predetermined recipe for the registration tool; obtain positions of a plurality of sample points as well as anchor points in the mask coordinate system measured by an inspection tool according to a predetermined recipe for the inspection tool; and calculate a correction function for sample points from the weight of anchor points and measured positions of the anchor points in both metrology and inspection tools. The correction function is applied to the sample points to provide a corrected registration map for the full mask.

In an embodiment, the weights, the recipe for the registration tool and the recipe for the inspection tool are obtained from a data preparation software module.

In an embodiment, the data of the measured positions of the anchor points and the measured positions of the sample points are used to generate along with the weights a corrected set of registration points bounded interpolation errors between anchor points over the entire mask.

The invention seeks to enable full mask registration map measurement. Metrology systems are not fast enough to cover the full mask. Inspection systems are not accurate enough for registration metrology. The invention proposes a way to combine both a metrology system and an inspection system in order to gain full mask registration mapping of masks.

The key advantage of the invention is the ability of the customer to obtain densely populated registration maps without any additional inspection or registration overhead and using existing capital equipment. The only additional requirement is that of the data preparation module and the data fusion module. The pre-processing and post-processing is realized with adequate software modules along with modifications to existing software of the registration tool and the inspection tool to enable the data gathering as required.

A novel feature of the present invention is the creation of a high-density registration map using a combination of (a few) anchor points from a mask registration tool and a larger number of sample points from the mask inspection tool. Furthermore, a novel feature is the use of a data preparation module (pre-processor) allowing the determination of appropriate locations (positions) of anchor points and sample points and the weights for the influence functions of the anchor points to achieve maximum accuracy in the final dense registration map. The use of a data fusion module (post-processor) is new, which casts the sample points in the coordinate frame of the mask imparted by the registration tool. The algorithms are used to bound interpolation errors between anchor points, and thus the entire mask is new. This permits the decoupling of the selection of anchor points which might be dependent on the mask design and the output data which might be use-case dependent.

High density registration maps of masks are becoming very important as the features (structures) on masks continue to shrink and requirements on wafer overlay become tighter. The registration of the masks with respect to one another affects both CD uniformity and overlay and hence is a key metric in ensuring adequate yields in a semiconductor fabrication. In addition, the emergence of multi-patterning has placed significant demands on mask overlay even within a single layer. The use of these high-density registration maps is multi-pronged. The invention allows a feedback to the mask writer. Furthermore, the acceptance or rejection as well as the qualification of a mask for the fabrication is enhanced. A feedforward of the mask to the scanner is possible. Additionally, it allows to determine the placement of patterns on EUV mask blanks.

### BRIEF DESCRIPTION OF THE DRAWINGS

Below, the invention and its advantages will be further described with reference to the accompanying figures in which:

FIG. 1 is a schematic view of a mask (reticle, photomask) with a plurality of patches;

FIG. 2 is a schematic enlarged view of a single patch with a plurality of randomly distributed anchor points;

FIG. 3 is a schematic view of a mask with swaths defined by an inspection tool;

FIG. 4 is a schematic view of the data preparation module with the inputs and the outputs;

FIG. 5 is a schematic setup of the inventive system for generating high density registration maps for masks;

FIG. 6 is a sparse registration map of a mask with the error vectors with the X-coordinate component and the Y-coordinate component determined by the registration tool of the system:

FIG. 7 is an image of a mask taken by the inspection tool with a plurality of swaths;

FIG. 8 is a possible influence function, showing the weight an anchor point has on adjacent sample points;

FIG. 9 is a further possible influence function, showing the weight an anchor point has on adjacent sample points; and,

FIG. 10 is a graphical representation of a corrected dense set of registration points error vectors on a mask.

### DETAILED DESCRIPTION OF THE INVENTION

In the figures like reference numerals are used for like elements or elements of like function. Furthermore, for the sake of clarity, only those reference numerals are shown in the figures which are necessary for discussing the respective figure.

In order to avoid an undue lengthiness of the specification it is not necessary to describe the well-known prior art coordinate measuring machine or metrology system (such as the IPRO-series of KLA Tencor), which is fully incorporated therein. For example, IPRO6 is a mask registration metrology tool designed to accurately measure and verify pattern placement performance of masks for the 1X nm node. It offers comprehensive characterization of mask pattern placement error, which is a direct contributor to intra-field wafer overlay error.

The same applies for the mask inspection tool (such as the TERON™ series of KLA Tencor) which is fully incorporated therein. The Teron™ reticle defect inspection system provides technologies to support IC fabs with mask monitoring of mask degradation and detecting yield-critical mask defects, such as haze growth defects or contamination in patterned and open areas. The Teron™ series mask defect inspection system can generate registration data as well as inspection data. The registration data from such a system is large in number (on the order of a million points per mask), but typically more limited in absolute accuracy than the registration tool.

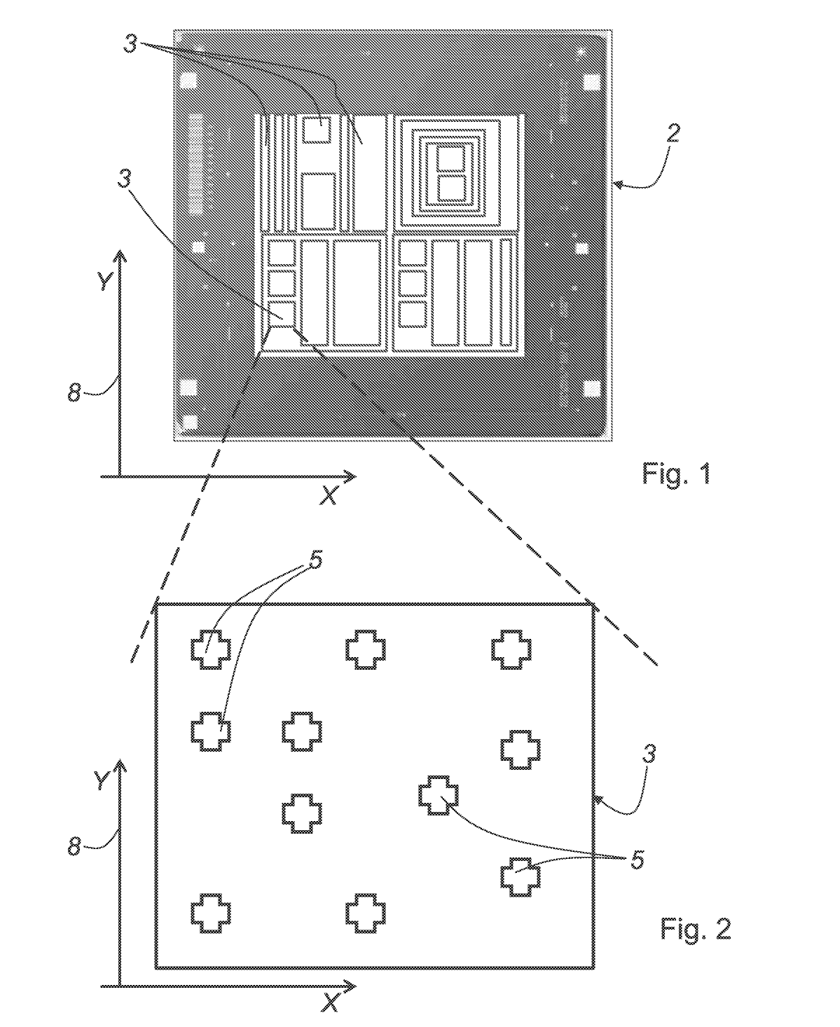

FIG. 1 shows a schematic representation of a mask 2 which has a plurality of patches 3 formed thereon, which encompass the structures (not shown) to be imaged on a wafer (not shown). The patches 3 are arrange on the mask in the x-coordinate X direction and the y-coordinate y direction on the mask 2

FIG. 2 is a schematic enlarged view of a single patch 3, wherein a plurality of anchor points 5 is defined within the patch 3. The random distribution of the anchor points 5 shown here should not be regarded as a limitation of the invention. It is clear for a skilled person that the anchor points 5 can be arranged as well on a uniformly spaced grid in the x-coordinate X direction and the y-coordinate y direction on the mask 2. The anchor points can consist of specially designed targets, or on-device pattern or an arbitrary mix of them.

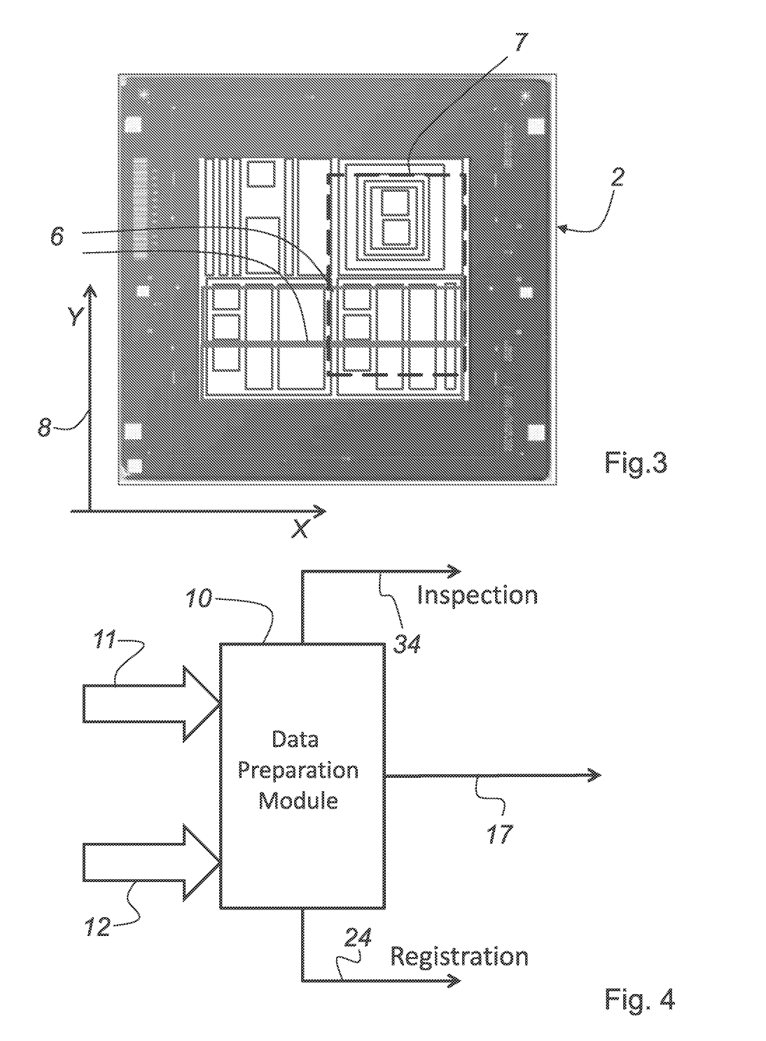

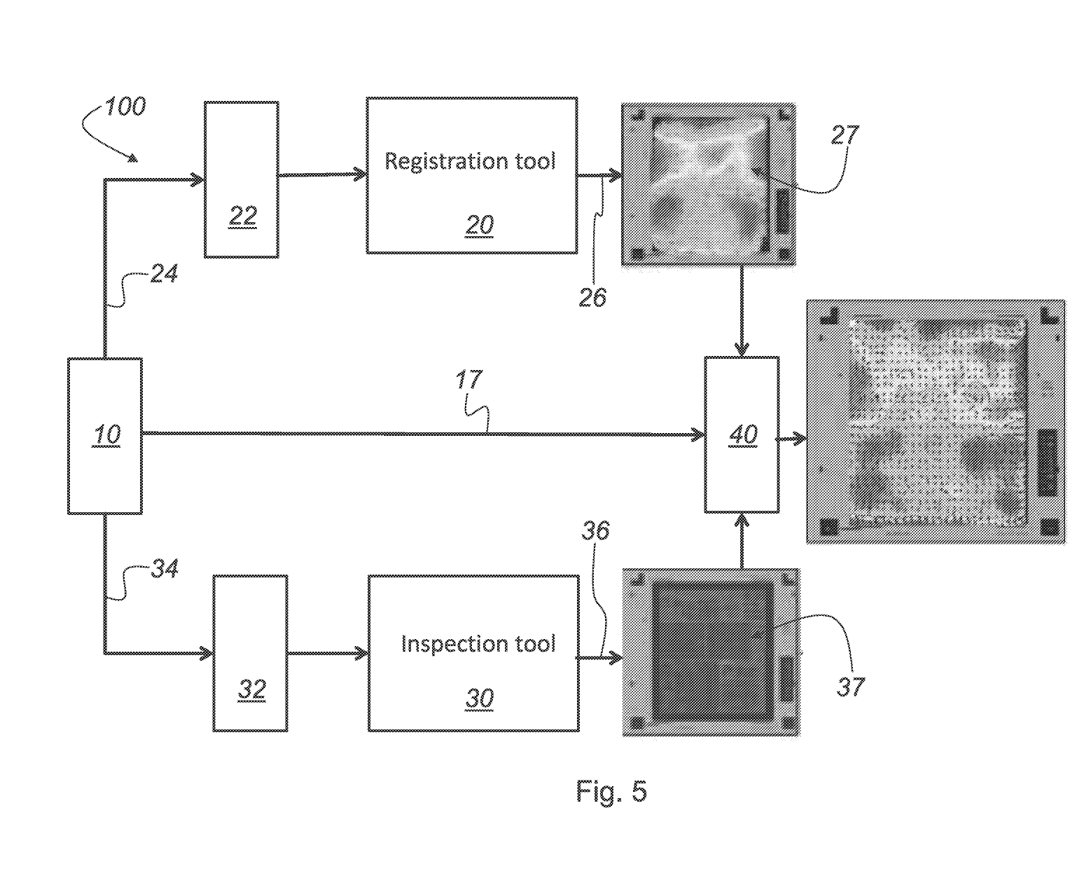

FIG. 3 is a schematic representation of a mask 2 with the plurality of patches 3 placed thereon. The inspection by the inspection tool 30 (see FIG. 5) is carried with a scanning approach using a TDI sensor (not shown) for example. Absolute accuracy is less important during mask inspection, since the primary motive is to detect and classify defects on the mask 2. The scanning approach provides image swaths 6 from the mask 2 which also can be divided up into sub-patches which are realigned algorithmically to remove low-frequency image shifts (such as those due to temperature fluctuations). Temperature fluctuations would further reduce absolute accuracy. A care area 7 on the mask 2 defines the area in which the high density registration map for a mask 2 is generated. The care area 7 could be as well the entire surface of the mask 2. It is understood that the care area 7 can take any form without departing from the spirit and scope of the present disclosure.

FIG. 4 is a detailed view of a data preparation module 10 which is used in the inventive system 100 as shown in FIG. 5. The data preparation module 10 is a pre-processing module that essentially generates the required recipes for mask inspection as well as mask registration. These recipes are in a form suitable for the integration with a first recipe generation module for 32 for the inspection tool 30 and a second recipe generation module 22 for the registration tool 20. In addition, the data preparation module 10 also generates weights 17 suitable for use in a data fusion module 40, which is used for further enhancement of the result quality/uncertainty. The data preparation module 10 also has at least a first input 11 and at least a second input 12. In the embodiment shown here, the data preparation module 10 receives a data base rendered image of the mask via the first input 11. The rendered image is for both the registration tool 20 and the inspection tool 30. Via the second input 12 the data preparation module 10 receives noise models for both the registration tool 20 and the inspection tool 30. It is understood that more than a first or second input to the data preparation module 10 may be utilized without departing from the spirit and scope of the present invention.

As shown in the schematic embodiment of the inventive system 100 for generating high density registration maps for masks of FIG. 5, the first input 11 and the second input 12 to the data preparation module 10 are used essentially as a constrained optimizer. In the embodiment shown in FIG. 5 the data preparation module 10 is connected with its first output 34 to the first recipe generation module 34. The second output 24 of the data preparation module 10 is connected to the second recipe generation module 22. The first recipe generation module 32 and the second recipe generation module 22 are considered as constrained optimizers. According to the embodiment shown here, the second recipe generation module 22 generates anchor points 5 for the registration tool 20 and with the generated recipe carries out registration of the anchor points 5. The first recipe generation module 32 generates sample points (not shown) for the inspection tool 30. With the generated recipe the inspection tool 30 carries out the inspection of the sample points on the mask 2. The inspection is carried out according to the recipe determined by the second recipe generation module 22.

It should be noted that neither the anchor points 5 nor the sample points need to be on uniformly spaced grids. The locations of these points as well as the weights 17 are determined by an evaluation of the expected measurement error on each of the metrology an inspection tools at those locations as well as consideration for overlay hotspots, etc. over a care area 7 of the mask 2.

In the embodiment shown in FIG. 5 the registration tool 20 is connected to the data preparation module 10 via the second recipe generation module 22. The inspection tool 30 is connected to the data preparation module 10 via the first recipe generation module 32. The inspection tool 30 then does the inspection and generates the various patches 3 that are evaluated to determine relative positions of the sample points with respect to the sample points on the same/adjacent swaths 6. All these measurements are done on the coordinate system 8 of the mask 2 as determined by the inspection tool 30. The inspection tool 30 with augmented software can generate registration data as well as inspection data. The registration data from the inspection tool 30 is large in number (on the order of a million points per mask), but typically more limited in absolute accuracy than the registration tool 20.

The registration tool 20 has an augmented software to generate registration data for the anchor points 5. The anchor points 5 are typically about a thousand in number, but the registration tool 20 can measure their location to the demanding accuracies required by the next few nodes of semiconductors.

The mask coordinate frame is established by the registration tool 20. Simultaneously, bounds are also established for potential errors between sample points according to a predetermined interpolation scheme. The customer can then choose to regrid the registration map over the sample points over a different set of points (on a regularly spaced grid, for example).

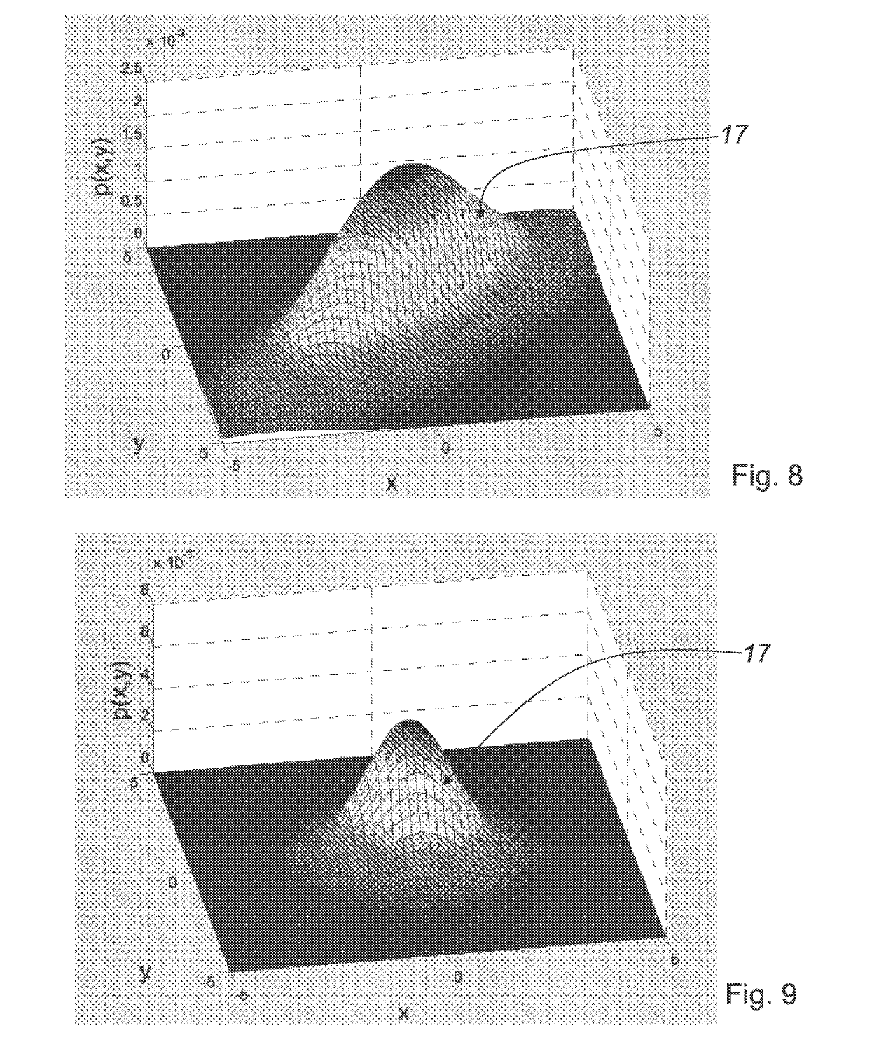

A data fusion module 40 is connected to the registration tool 20, the inspection tool 30 and the data preparation module 10. The weights 17 were previously determined by the data preparation module 10. The weights 17 are used as influence functions (see FIG. 8 and FIG. 9) to determine the influence of an anchor point 5 (registration of the anchor point 5 is determined by the registration tool 20) on the adjacent sample points (determined by the inspection tool 30).

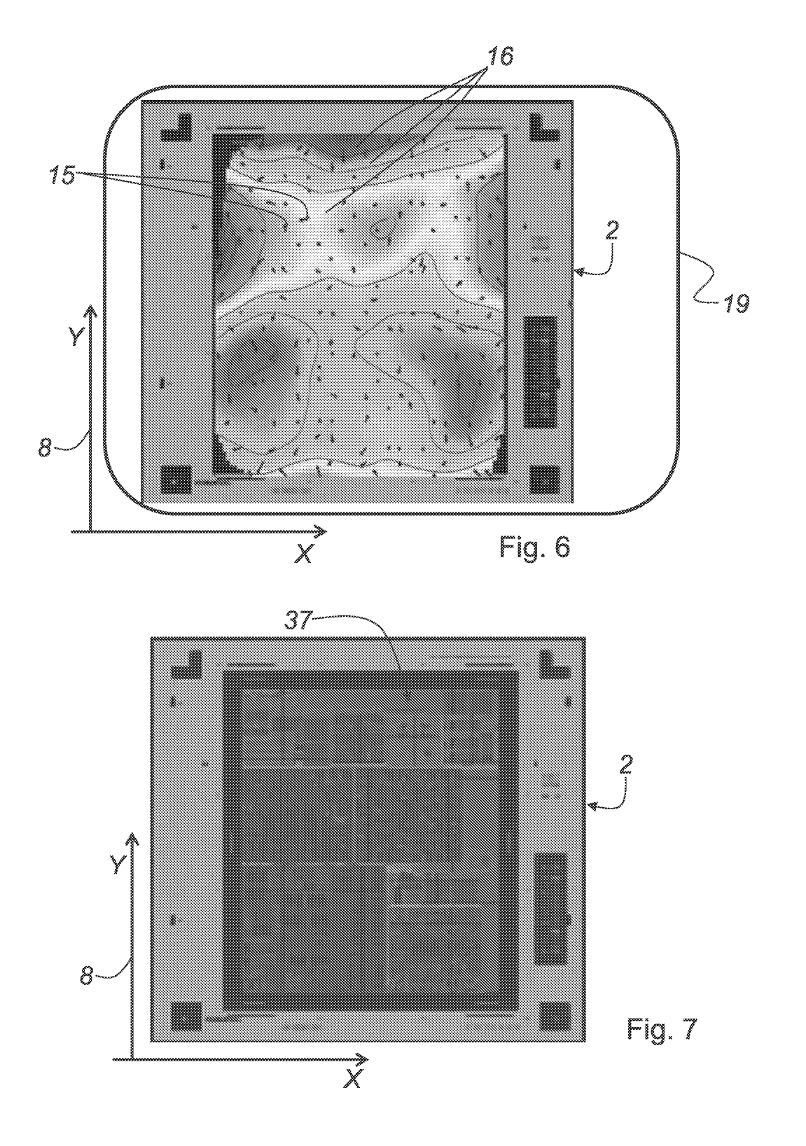

As an output from the registration tool 20 one could obtain a graphical representation 27 of the registration of the anchor points 5 as disclosed in FIG. 6. The anchor points 5 are shown with error bars 15, indicating the registration deviation in the x-coordinate direction X and in the y-coordinate direction Y. The image of the mask 2 with the error bars 15 is shown on a display 19, wherein colored areas 16 provide an indication that within the colored areas 16 with the same color the error bars 15 are mainly oriented within a predetermined direction range.

FIG. 7 is an image 37 of a mask 2 taken by the inspection tool with a plurality of swaths 6. The image 37 contains the sample points which are distributed over the entire mask 2.

The data fusion module 40, as shown in FIG. 5 receives a data output 26 of the registration tool 20 and a data output 36 of the inspection tool 30. The data from the inspection tool 30 contain the sample points over the entire mask 2. These sample points are then combined (or fused) in the data fusion module 40 with the positions of the anchor points 5, which are determined by registration tool 20 in the mask 2 coordinate system 8. The data preparation module 10 also generates weights 17 suitable for use in the data fusion module 40 used for further enhancement of the result quality/uncertainty.

Two possible weights (influence functions) are shown in FIG. 8 and FIG. 9. The weights 17 illustrate the influence that an anchor point 5 has on adjacent sample points in the x-coordinate X direction and in the y-coordinate Y direction. The whole process of determining the locations or positions on the anchor points 5 and their weights 17 are implemented in the data preparation module 10 (see FIG. 5). As described above the data preparation module 10 takes into account the noise models of the registration tool 20 and the inspection tool 30 as well as the image pattern on the mask 2.

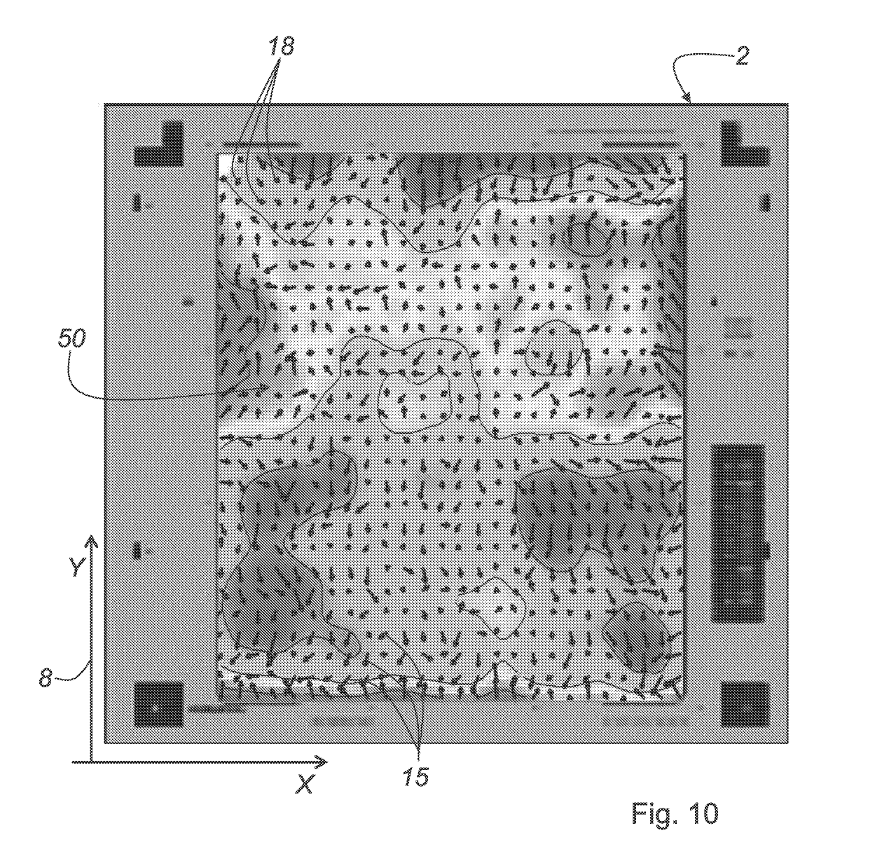

FIG. 10 is a graphical representation of a corrected set of registration points with error bars 15 on a mask 2. As described above (see FIG. 5), the data fusion module 40 carries out the post-processing, that takes the registration data from both the registration tool 20 (anchor points 5) and the inspection tool 30 (swaths 6) along with the weights 17 generated by the data preparation module 10. In the embodiment shown here the anchor points 5 are placed on a regular grid. The output of the data fusion module 40 provides a corrected set of registration points 18, which are as well placed on a regular grid. These registration points 18 may (but are not limited to) essentially remain at the same locations as those generated by the inspection tool 30 and have the (weighted) corrections from the registration tool 20 applied to them. Along with a registration map 50, the data fusion module 40 also generates error bars 15 for registration accuracy for the region between each registration point 18 and its neighbors, thus guaranteeing bounded accuracy figures of merit over the entire mask 2.

It is believed that the method and system of the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory.

### LIST OF REFERENCE NUMERALS

2 mask
3 patch
5 anchor point
6 swath
7 care area
8 coordinate system of mask
10 data preparation module
11 first input
12 second input
14 third data output
15 error bars
16 colored areas
17 weight
18 registration points
19 display
20 registration tool
22 second recipe generation module
24 second output
26 data output of the registration tool
27 graphical representation
30 inspection tool
32 first recipe generation module
34 first output
36 data output of the inspection tool
37 image
40 data fusion module
50 registration map
100 system
X X-coordinate
Y X-coordinate

1. A method for generating a high density registration map for a mask comprising:
a) generating in a data preparation module from a design database of the mask and from a noise model of a registration tool a plurality of anchor points and a recipe for the registration tool;
b) generating in the data preparation module from the design database of the mask and from a noise model of an inspection tool a plurality of sample points and a recipe for the inspection tool;
c) generating weights in the data preparation module;
d) measuring positions of the anchor points in a mask coordinate system with the registration tool according to the recipe;
e) measuring positions of the sample points in the mask coordinate system with respect to sample points on a same or adjacent swaths with the inspection tool according to the recipe; and
f) passing the positions of the anchor points and the positions of the sample points to a data fusion module, to determine a corrected set of registration points under the influence of the weights of an anchor point on adjacent sample points.

2. The method of claim 1, wherein a graphical representation of the registration map of the mask is displayed on a display showing the corrected set of registration points, wherein each registration point is provided with an error vector.

3. The method of claim 1, wherein the sample points, the anchor points and the weights are determined by a mask error enhancement function.

4. The method of claim 1, wherein the number of anchor points is less than the number of sample points.

5. The method of claim 4 wherein approximately 103 anchor points are generated.

6. The method of claim 4, wherein approximately 106 sample points are generated.

7. The method of claim 1, wherein the sample points, which are measured by the inspection tool, are cast over an entirety of the mask by the data fusion module, according to the weights, into a mask coordinate frame as established by the registration tool to obtain the registration map of the mask.

8. The method of claim 7, wherein the weights are used to determine an influence of a specific anchor point on the adjacent sample points in the mask coordinate frame.

9. The method of claim 7, wherein bounds are established for potential errors between sample points according to a predetermined interpolation scheme.

10. The method of claim 9, wherein the predetermined interpolation is realized by using influence functions.

11. The method of claim 2, wherein a user can regrid the registration map displayed on the display over the sample points over a different set of points.

12. The method of claim 11, wherein the different set of points is on a regularly spaced grid.

13. A system for generating a high density registration map for a mask comprising:
a data preparation software module which generates a plurality of anchor points, a plurality of sample points, a plurality of weights and at least one first recipe and at least one second recipe;
a registration tool connected to the data preparation software module to determine data for positions of the anchor points on the mask as well as image render parameters learned from the mask with regard to the at least one first recipe;
an inspection tool connected to the data preparation software module to determine data for positions of the sample points on the mask with regard to the at least one second recipe; and
a data fusion software module connected to the registration tool, the inspection tool and the data preparation software module in order to generate with the weights at least one registration map with a corrected set of registration points.

14. The system according to claim 13, wherein the data preparation software module has at least a first input for providing mask design data in order to render an image of the mask for the registration tool and the inspection tool, and a second input for providing a noise model for the registration tool and the inspection tool.

15. The system according to claim 13, wherein a first recipe module is connected to an anchor point output of the data preparation software module and connected to an input of the registration tool, and a second recipe module is connected to a sample point output of the data preparation software module and connected to an input of the inspection tool.

16. The system of claim 13, wherein the data fusion software module is configured to take the data for the positions of the anchor points via an output of the registration tool and the data for the positions of the sample points via an output of the inspection tool and to generate a corrected set of registration points along with the weights.

17. The system of claim 16, wherein a display is connected to the data fusion module for displaying bounded interpolation errors between anchor points over an entirety of the mask.

18. The system of claim 13, wherein the number of anchor points is less than the number of sample points.

19. A computer program product disposed on a non-transitory computer readable medium comprising:
computer executable process steps operable to control a computer for:
obtaining positions of a plurality of anchor points in a mask coordinate system measured by a registration tool according to a predetermined recipe for the registration tool;
obtaining positions of a plurality of sample points in the mask coordinate system measured by an inspection tool according to a predetermined recipe for the inspection tool; and
calculating from the positions of the anchor points and the positions of the sample points with an influence of weights of anchor points on adjacent sample points on a registration map.

20. The computer program product of claim 19, wherein the weights, the predetermined recipe for the registration tool and the predetermined recipe for the inspection tool are obtained from a data preparation software module.

21. The computer program product of claim 19, wherein data of the positions of the anchor points and the positions of the sample points are used to generate along with the weights a corrected set of registration points and bounded interpolation errors between anchor points over an entirety of a mask.
